(19) United States
(12) Patent Application Publication
(10) Pub. No.: US 2010/0185487 A1
(43) Pub. Date: Jul. 22, 2010

(54) AUTOMATIC COLLECTION AND CORRELATION OF RETAIL METRICS

(76) Inventors: Sergio Borger, Demarest, NJ (US); Tsz Cheng, Grand Prairie, TX (US); Riju Pahwa, White Plains, NY (US); Yashodhara M. Patnaik, Yorktown Heights, NY (US)

Correspondence Address: HOFFMAN WARNICK LLC, 75 STATE ST, 14 FL, ALBANY, NY, 12207, US

(21) Appl. No.: 12/356,823

(22) Filed: Jan. 21, 2009

(51) Int. Cl. G06F 17/30

(52) U.S. Cl. 705/10

(57) ABSTRACT

The invention provides a method, system, and program product for collecting and correlating retail metrics. In one embodiment, the invention includes providing a spatial representation of a retail space containing a plurality of products, automatically collecting data representing movement of at least one customer within the retail space, obtaining data related to products purchased by the at least one customer, and transforming the movement data and the purchasing data into correlation data representing temporal, spatial, and purchasing metrics within the retail space.

### TECHNICAL FIELD

The present invention relates generally to retail metrics and, more particularly, to the automatic collection and correlation of retail metrics.

### BACKGROUND OF THE INVENTION

Retailers often consider data from point-of-sale (POS) transaction systems in making forecasts and supply chain decisions. Many retailers also use these data in planning for product placement, store layout, category locations, signage locations, promotion placement, etc.

To be of real value, however, data from a POS transaction system is combined with data related to the number of customers and their individual and collective movements throughout a retail space. To date, such “foot traffic” data have required the manual counting and tracking of customers within the retail space. Such methods are undesirable for several reasons, including, for example, the expense involved, the need to input and combine the “foot traffic” data with the POS data at some point after these data are collected, and the disruption of customers' normal shopping routines.

Accordingly, there exists a need in the art to overcome the deficiencies and limitations described hereinabove.

### SUMMARY OF THE INVENTION

The invention provides a method, system, and program product for collecting and correlating retail metrics.

A first aspect of the invention provides a method of collecting and correlating retail metrics, the method comprising: providing a spatial representation of a retail space containing a plurality of products; automatically collecting data representing movement of at least one customer within the retail space; obtaining data related to products purchased by the at least one customer; and transforming the movement data and the purchasing data into correlation data representing temporal, spatial, and purchasing metrics within the retail space.

A second aspect of the invention provides a system for collecting and correlating retail metrics, the system comprising: a system for providing a spatial representation of a retail space containing a plurality of products; a system for automatically collecting data representing movement of at least one customer within the retail space; a system for obtaining data related to products purchased by the at least one customer; and a system for transforming the movement data and the purchasing data into correlation data representing temporal, spatial, and purchasing metrics within the retail space.

A third aspect of the invention provides a program product stored on a computer-readable medium, which when executed, collects and correlates retail metrics, the program product comprising: program code for providing a spatial representation of a retail space containing a plurality of products; program code for automatically collecting data representing movement of at least one customer within the retail space; program code for obtaining data related to products purchased by the at least one customer; and program code for transforming the movement data and the purchasing data into correlation data representing temporal, spatial, and purchasing metrics within the retail space.

A fourth aspect of the invention provides a method for deploying an application for collecting and correlating retail metrics, comprising: providing a computer infrastructure being operable to: provide a spatial representation of a retail space containing a plurality of products; automatically collect data representing movement of at least one customer within the retail space; obtain data related to products purchased by the at least one customer; and transform the movement data and the purchasing data into correlation data representing temporal, spatial, and purchasing metrics within the retail space.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1-6 show a spatial representation of a retail space and its use in various embodiments of the invention;

FIG. 7 shows an example of point-of-sale (POS) data suitable for use in various embodiments of the invention;

FIG. 8 shows a detailed view of a portion of the retail space in FIGS. 1-6, including correlated data representing movement of a customer within the retail space and POS data for that customer;

FIG. 9 shows a flow diagram of an illustrative method according to the invention; and

FIG. 10 shows a block diagram of an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

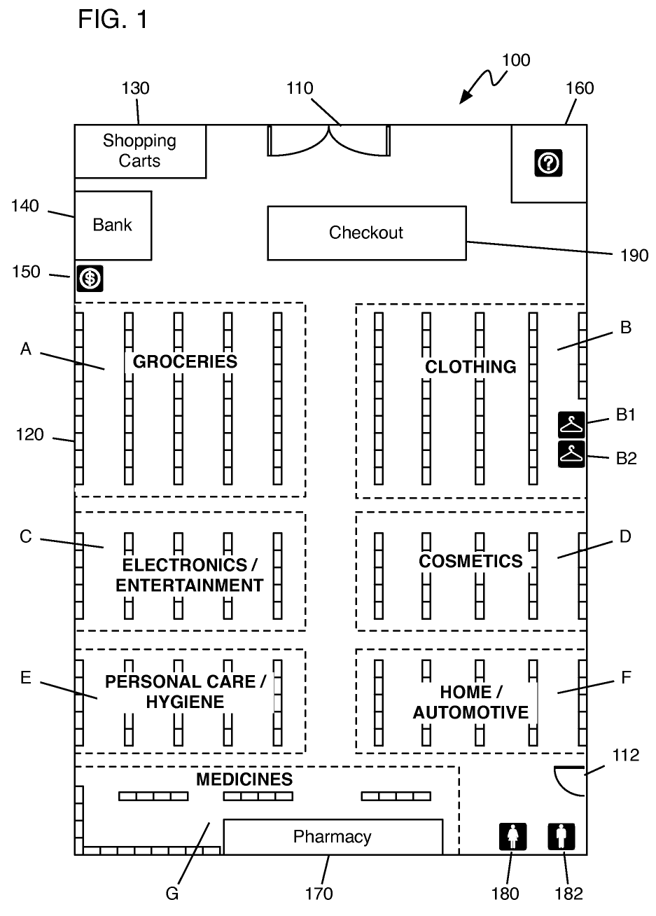

FIG. 1 shows a spatial representation 100 of a retail space. As in most retail spaces, the spatial representation 100 includes a plurality of retail departments A-G, as well as other common fixtures, amenities, and services, such as entrances/exits 110, 112, shelving 120, shopping cart storage 130, a bank 140, an ATM 150, a customer service center 160, a pharmacy 170, restrooms 180, 182, and a checkout area 190. Other fixtures, amenities, or services may also be included. Some fixtures, amenities, or services may be common to the retail space or specific to a particular department or area. For example, while the restrooms 180, 182 are common to the retail area as a whole, fitting rooms B1, B2 are specific to the clothing department B. Other arrangements and representations of the retail space are possible, of course, and are within the scope of the invention.

Within the retail space, the position of retail departments, categories of products, individual products, or each, may be determined using a global positioning system (GPS), radio frequency identification (RFID) system, or some other known or later-developed technology. As will be described in greater detail below, in such an embodiment, the movement of a customer within the retail space may be determined or confirmed based on data related to one or more products purchased by the customer.

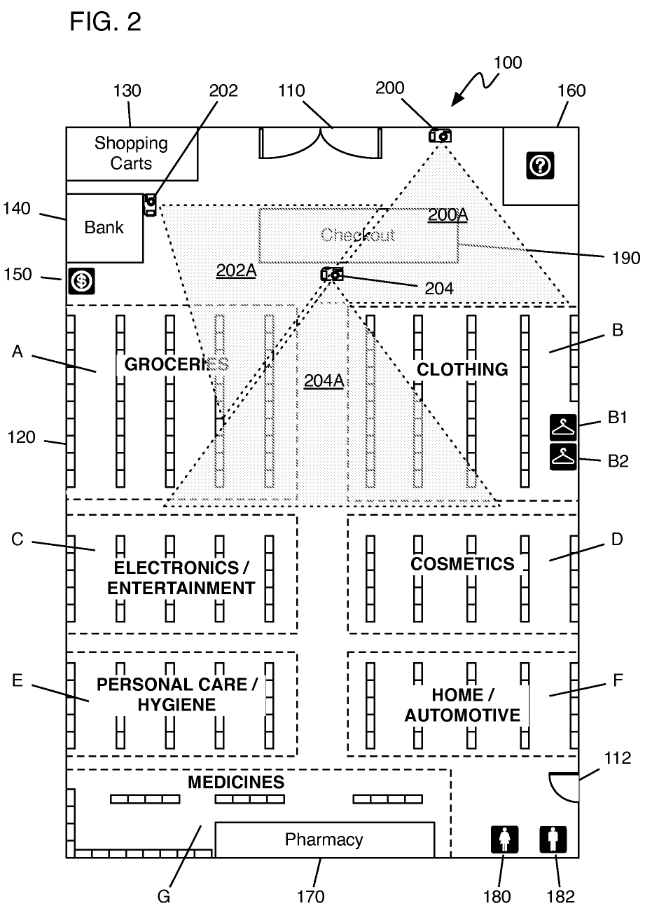

In FIG. 2, a plurality of video cameras 200, 202, 204 are shown, as well as their respective fields of view 200A, 202A, 204A. One or more of the plurality of video cameras 200, 202, 204 are employed to automatically collect data representing movement of customers within the retail space. Software applications for recognizing and tracking persons within video images are known in the art. Any such application may be employed in practicing embodiments of the invention.

For purposes of clarity and illustration, FIG. 2 includes only three video cameras and their respective fields of view. It will be recognized, of course, that more or fewer video cameras may be employed, the precise number being determined, for example, by the size and layout of the retail space. In many instances, the fields of view of two or more video cameras may overlap.

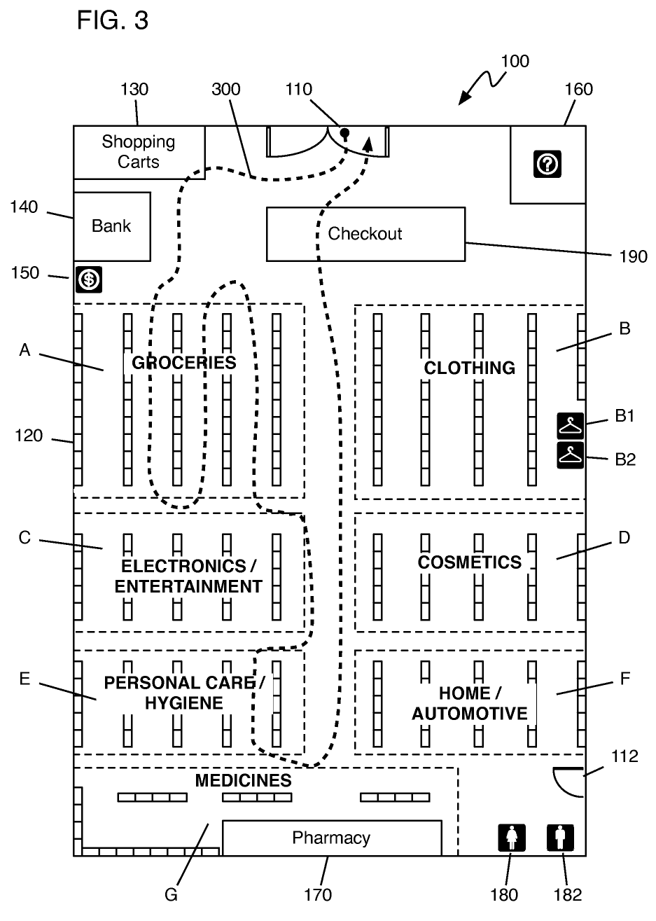

FIG. 3 shows a path 300 of a first customer within the retail space, based on data collected by the plurality of video cameras. (For purposes of clarity, the video cameras and their fields of view of FIG. 2 are not shown in FIGS. 3-6.) As can be seen, the first customer collected a shopping cart from the shopping cart storage 130, traveled through three aisles of the grocery department A and one aisle of the personal care/hygiene department E, and then proceeded to the checkout 190. If data on the products purchased by the first customer indicate that the first customer purchased products in both the grocery department A and the personal care/hygiene department E, and that this pattern of purchasing is common (i.e., customers who purchase groceries often also purchase one or more products from the personal care/hygiene department E), the correlation of data related to the movement of the customers and their purchases may be used, for example, to reorganize the layout of the retail space. For example, it may be preferable, based on such correlated data, to move the personal care/hygiene department E adjacent the grocery department A (e.g., swap the locations of the electronics/entertainment department C and the personal care/hygiene department E).

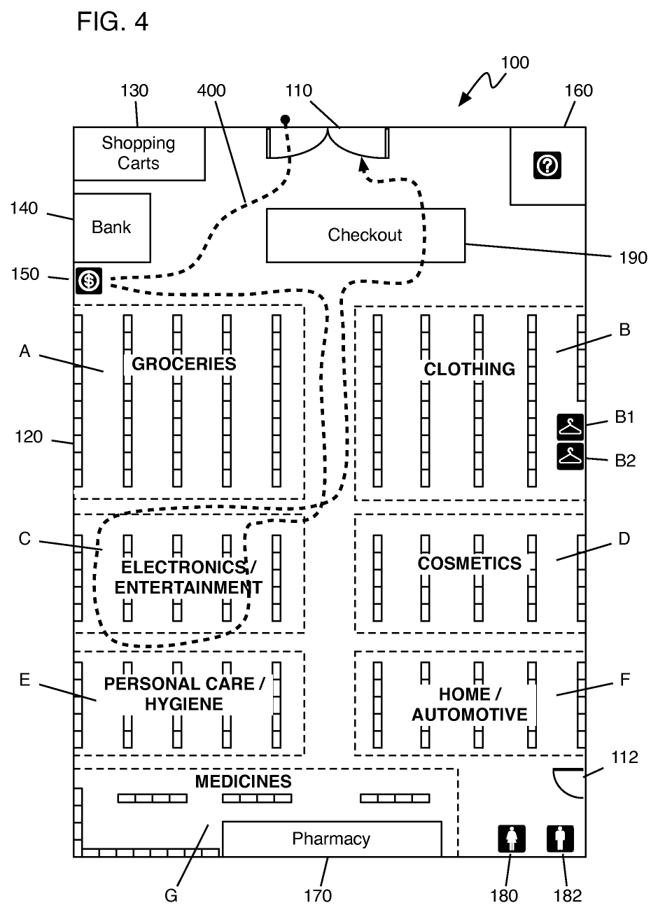

FIG. 4 shows the path 400 of a second customer within the retail space. As can be seen, the second customer did not collect a shopping cart from the shopping cart storage 130, but did visit the ATM 150 before traveling through two aisles of the electronics/entertainment department C and then proceeding to the checkout 190. Here, it may be useful for any number of reasons to correlate data representing movement of the second customer with data related to the products he/she purchased. For example, the fact that the second customer visited the ATM 150 prior to purchasing one or more products within the electronics/entertainment department C, if such activities are representative of other customers as well, may indicate that a higher percentage of purchases within the electronics/entertainment department C are paid for with cash and/or that customers visiting the ATM 150 typically only purchase products within a single department. Correlating such data may suggest to a manager of the retail space that certain advertisements (e.g., for sale items in the electronics/entertainment department C) may be better placed near the ATM 150 than in other areas of the retail space.

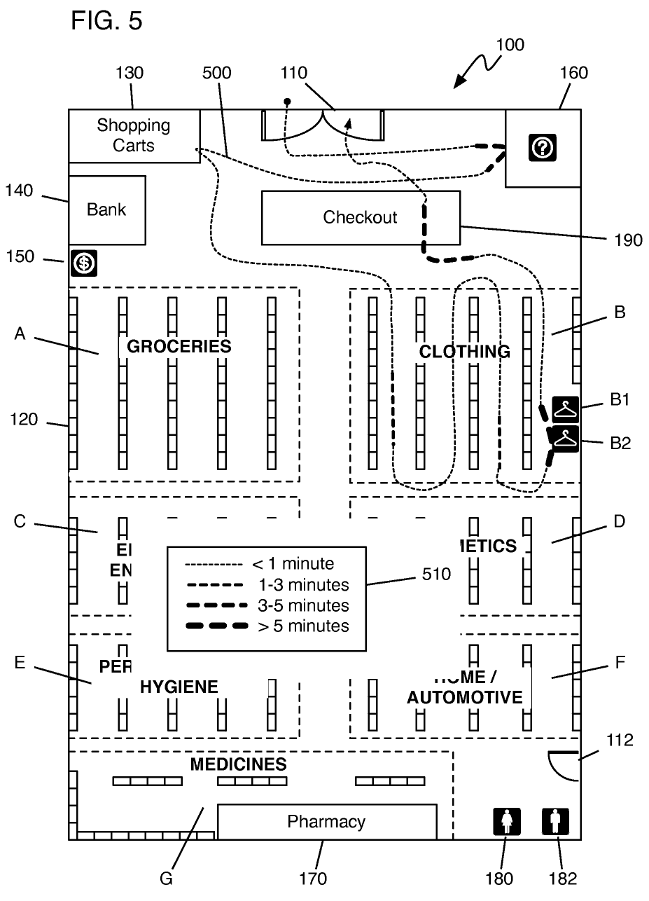

In FIG. 5, the path 500 of a third customer is shown. Here, however, the path 500 includes a temporal component, represented by the legend 510. As can be seen, the third customer first visited the customer service center 160 and spent 3-5 minutes there. Next, the third customer collected a shopping cart from the shopping cart storage 130, traveled through four aisles of the clothing department B, including time spent in a fitting room B2, and then proceeded to the checkout 190.

Again, correlating data representing the movement of the third customer with data related to products he/she purchased may be useful for a number of reasons. Such correlated data may reflect browsing and/or decision making patterns of the third customer (e.g., the fact that he/she spent no more than 1-3 minutes at any location within the aisles of the clothing department B may suggest that he/she had already decided which items to purchase, based on advertisements or other information). Such correlated data may also reflect a need for improvement in services or amenities offered to customers. For example, as shown in FIG. 5, the third customer spent the greatest amounts of time at the customer service center 160, in the fitting room B2, and at the checkout 190. Had the third customer spent less time utilizing these services and amenities, for example, the total value of products purchased may have been higher. This may be borne out by comparing the correlated data representing the purchases and movements of other customers who spent the same total time within the retail space but less time utilizing these services and amenities.

While the paths 300, 400, 500 in FIGS. 3-5 are shown as the paths of individual customers within the retail space, it should be recognized that this is for purposes of clarity only. The paths of all customers could be shown together and correlated with the purchasing data of all customers to yield an overall depiction of movement and purchasing within the retail space.

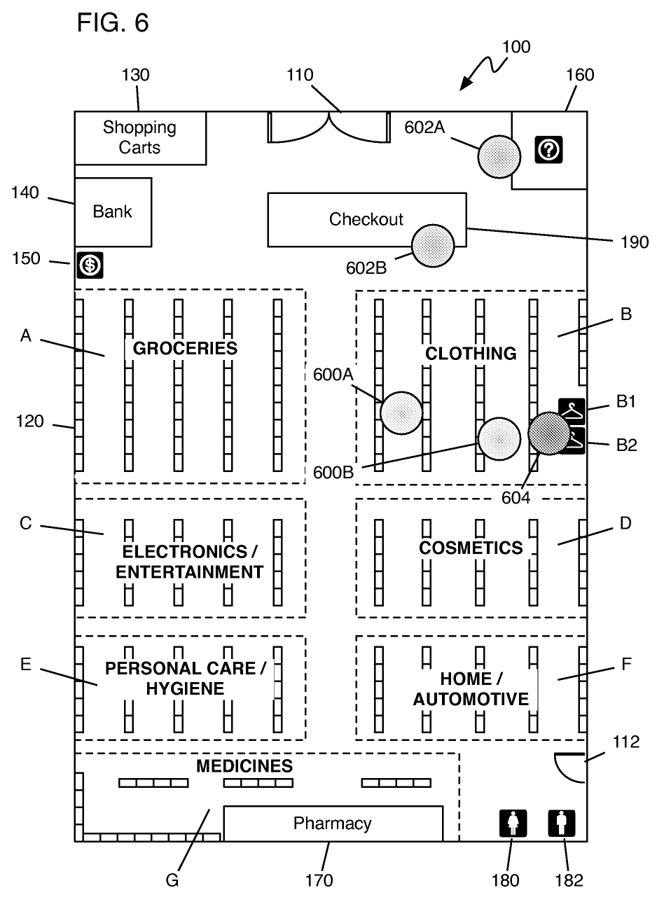

FIG. 6 shows temporal “hot spots” 600A-B, 602A-B, 604 within the retail space based on the path 500 (FIG. 5) of the third customer. Again, while shown as based upon the path of a single customer, such hot spots could alternatively be based upon the paths of all customers or some subset of customers (e.g., those making purchases within the clothing department B). In addition, while shown in FIG. 6 as temporal hot spots (i.e., locations where a customer spent the most time), hot spots could be based on another criterion or combination of criteria, such as products purchased, total purchase amounts within a particular department, or purchases within a category of products within a department.

In some embodiments of the invention, a customer's movement within the retail space may be determined by, correlated with, or confirmed with data representing adjacency of the customer to a product within the retail space. For example, if it is determined that a customer purchased a particular product, the path of the customer may be determined based on the position of that product within the retail space (which may be determined by GPS, RFID, etc.). Such an embodiment may be useful, for example, to confirm movement data collected using a video camera or to collect movement data that, for any number of reasons, cannot be or was not collected with a video camera.

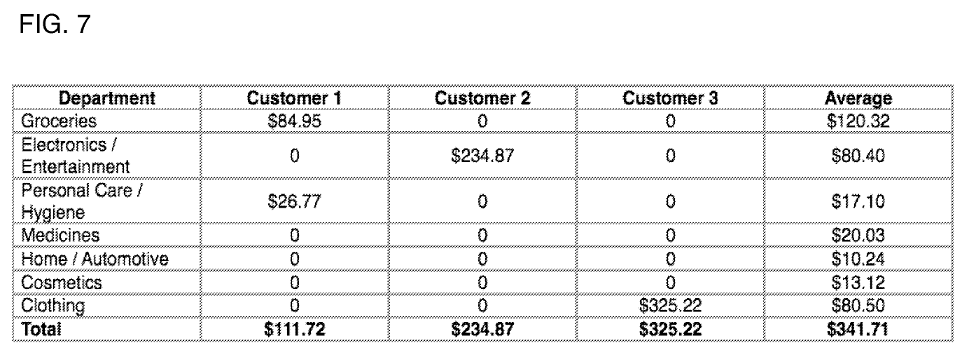

FIG. 7 shows the type of point-of-sale (POS) data that may be combined with customer movement data in order to obtain correlation data representing temporal, spatial, and/or purchasing metrics within the retail space. Here, the total dollar value of the purchases of each customer within each department are shown, along with the average dollar value of the purchases of all customers within each department. Other data may be used similarly, of course. For example, the prices and/or number of individual products purchased, the prices and/or number of products on sale, or the prices and/or number of new (i.e., newly offered for sale in the retail space) items purchased may all be combined with customer movement data in order to obtain useful correlation data.

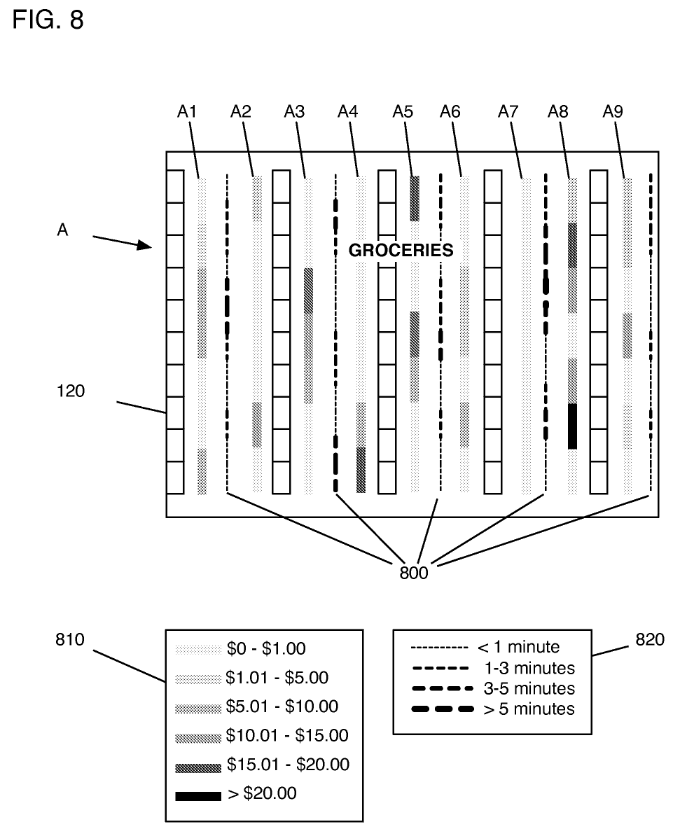

FIG. 8 shows a detailed view of the grocery department A showing a customer path 800 and a graphical depiction of POS data A1-A9 representing the dollar values of purchases made along the customer path 800. Legends 810 and 820 show dollar value ranges and temporal durations, respectively. These ranges and durations are shown for purposes of illustration only and it will be recognized that other ranges and/or durations may be used.

The correlated data shown in FIG. 8 may be used in any number of ways. For example, where the customer path 800 shows that the customer spent a prolonged period in a particular area of the grocery department A, but the value of his/her purchases in this area are low, it may be an indication to a manger of the retail space that the customer spent some time deciding whether to purchase items in this area but ultimately decided not to. Consequently, lowering the prices of items in this area may increase the likelihood that they will be purchased.

In other cases, the correlated customer path 800 and POS data may suggest that a rearrangement of products within the retail space may increase sales. For example, the POS data in A7 and A8 show that, while the customer spent a fair amount of time in the aisle, the vast majority of the customer's purchases came from one side of the aisle, as shown in POS data A8. If this trend is representative of the movement and purchasing patterns of other customers, a rearrangement of products in the aisle (e.g., mixing items from the side of the aisle represented by A8 with items from the side represented by A7) may increase the sales of all items in the aisle. For example, it is possible that, due to product arrangement or placement, customers within the aisle focus primarily on products along the side of the aisle represented by A8, but that if their attention could be directed to products on the other side of the aisle, the sale of those products would increase. It should be noted that other uses of the correlated data shown in FIG. 8, or of other correlated movement and purchasing data, are possible, and are within the scope of the invention.

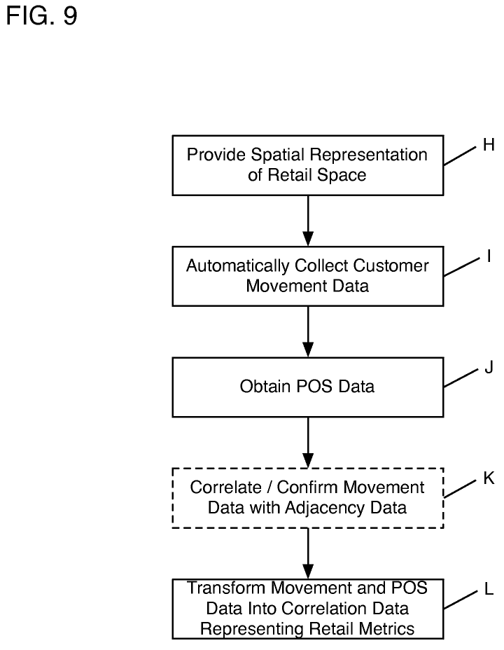

FIG. 9 shows a flow diagram of a method according to one embodiment of the invention. At H, a spatial representation of a retail space is provided, such as that shown in FIGS. 1-6. At I, data representing movement of at least one customer within the retail space is automatically collected. As noted above, such data may be collected using one or more video cameras within the retail space.

At J, POS data are obtained. At K, the movement data collected at I may optionally be correlated or confirmed with adjacency data derived from the POS data obtained at J. Finally, at L, the movement data collected at I and the POS data obtained at J are transformed into correlation data representing retail metrics (e.g., temporal, spatial, and purchasing metrics) within the retail space.

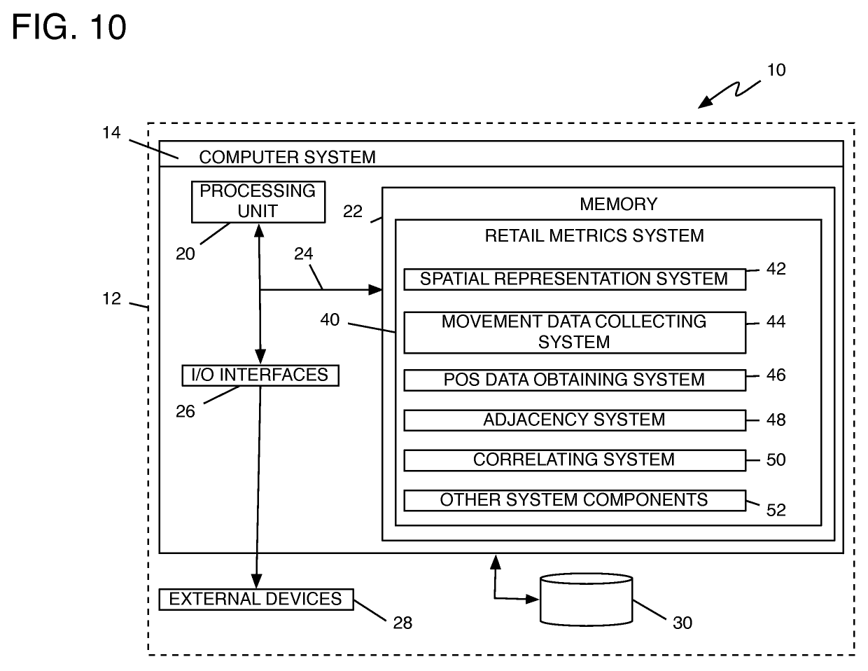

FIG. 10 shows an illustrative system 10 for collecting and correlating retail metrics. To this extent, system 10 includes a computer infrastructure 12 that can perform the various process steps described herein for collecting and correlating retail metrics. In particular, computer infrastructure 12 is shown including a computer system 14 that comprises retail metrics system 40, which enables computer system 14 to collect and correlate retail metrics by performing the process steps of the invention.

Computer system 14 is shown including a processing unit 20, a memory 22, input/output (I/O) interfaces 26, and a bus 24. Further, computer system 14 is shown in communication with external devices 28 and a storage system 30. As is known in the art, in general, processing unit 20 executes computer program code, such as retail metrics system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and retail metrics system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, the retail metrics system 40 enables the computer system 14 to collect and correlate retail metrics. To this extent, the retail metrics system 40 is shown including a spatial representation system 42, a movement data collecting system 44, a point-of-sale (POS) data obtaining system 46, an adjacency system 48, and a correlating system 50. Operation of each of these systems is discussed above. The retail metrics system 40 may further include other system components 52 to provide additional or improved functionality to the retail metrics system 40. It is understood that some of the various systems shown in FIG. 10 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for collecting and correlating retail metrics, it is understood that the invention further provides various alternative embodiments. For example, in one embodiment, the invention provides a computer-readable medium that includes computer program code to enable a computer infrastructure to collect and correlate retail metrics. To this extent, the computer-readable medium includes program code, such as retail metrics system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to collect and correlate retail metrics, as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for collecting and correlating retail metrics. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of collecting and correlating retail metrics, the method comprising:
providing a spatial representation of a retail space containing a plurality of products;
automatically collecting data representing movement of at least one customer within the retail space;
obtaining data related to products purchased by the at least one customer; and
transforming the movement data and the purchasing data into correlation data representing temporal, spatial, and purchasing metrics within the retail space.

2. The method of claim 1, wherein the spatial representation includes a planogram depicting at least one of the following: retail departments, categories within retail departments, products within categories, and retail fixtures.

3. The method of claim 1, wherein the data representing movement of the at least one customer is collected using a video camera.

4. The method of claim 1, wherein the data representing movement of the at least one customer includes data representing time spent by the at least one customer within each of a plurality of locations within the retail space.

5. The method of claim 4, wherein the plurality of locations includes a plurality of retail departments.

6. The method of claim 1, wherein the data representing movement of the at least one customer includes data representing adjacency of the at least one customer to a product within the retail space and purchased by the at least one customer.

7. A system for collecting and correlating retail metrics, the system comprising:
a system for providing a spatial representation of a retail space containing a plurality of products;
a system for automatically collecting data representing movement of at least one customer within the retail space;
a system for obtaining data related to products purchased by the at least one customer; and
a system for transforming the movement data and the purchasing data into correlation data representing temporal, spatial, and purchasing metrics within the retail space.

8. The system of claim 7, wherein the spatial representation includes a planogram depicting at least one of the following: retail departments, categories within retail departments, products within categories, and retail fixtures.

9. The system of claim 7, wherein the data representing movement of the at least one customer is collected using a video camera.

10. The system of claim 7, wherein the data representing movement of the at least one customer includes data representing time spent by the at least one customer within each of a plurality of locations within the retail space.

11. The system of claim 10, wherein the plurality of locations includes a plurality of retail departments.

12. The system of claim 7, wherein the data representing movement of the at least one customer includes data representing adjacency of the at least one customer to a product within the retail space and purchased by the at least one customer.

13. A program product stored on a computer-readable medium, which when executed, collects and correlates retail metrics, the program product comprising:
program code for providing a spatial representation of a retail space containing a plurality of products;
program code for automatically collecting data representing movement of at least one customer within the retail space;
program code for obtaining data related to products purchased by the at least one customer; and
program code for transforming the movement data and the purchasing data into correlation data representing temporal, spatial, and purchasing metrics within the retail space.

14. The program product of claim 13, wherein the spatial representation includes a planogram depicting at least one of the following: retail departments, categories within retail departments, products within categories, and retail fixtures.

15. The program product of claim 13, wherein the data representing movement of the at least one customer is collected using a video camera.

16. The program product of claim 13, wherein the data representing movement of the at least one customer includes data representing time spent by the at least one customer within each of a plurality of locations within the retail space.

17. The program product of claim 16, wherein the plurality of locations includes a plurality of retail departments.

18. The program product of claim 13, wherein the data representing movement of the at least one customer includes data representing adjacency of the at least one customer to a product within the retail space and purchased by the at least one customer.

19. A method for deploying an application for collecting and correlating retail metrics, comprising:
providing a computer infrastructure being operable to:
provide a spatial representation of a retail space containing a plurality of products;
automatically collect data representing movement of at least one customer within the retail space;
obtain data related to products purchased by the at least one customer; and
transform the movement data and the purchasing data into correlation data representing temporal, spatial, and purchasing metrics within the retail space.

20. The method of claim 19, wherein the data representing movement of the at least one customer is collected using a video camera and the spatial representation includes a planogram depicting at least one of the following: retail departments, categories within retail departments, products within categories, and retail fixtures.

21. The method of claim 19, wherein the data representing movement of the at least one customer includes data representing adjacency of the at least one customer to a product within the retail space and purchased by the at least one customer.
